(19) United States
(12) Patent Application Publication
(10) Pub. No.: US 2015/0202671 A1
(43) Pub. Date: Jul. 23, 2015

(54) METHOD FOR SHAPING A WORKPIECE

(71) Applicant: DEVAD GMBH, Teltow (DE)

(72) Inventors: Holger Hielscher, Teltow (DE); Harald Hielscher, Stahnsdorf (DE); Thomas Hielscher, Potsdam (DE)

(21) Appl. No.: 14/420,097

(22) PCT Filed: Aug. 7, 2013
(86) PCT No.: PCT/EP2013/066554

§ 371 Date: Feb. 6, 2015

Related U.S. Application Data
(60) Provisional application No. 61/680,479, filed on Aug. 7, 2012.

(51) Int. Cl. B21C 1/00; B23B 29/12; B21D 37/18

(52) U.S. Cl. CPC B21C 1/006; B21D 37/18; B23B 29/125; B23B 2270/10

(57) ABSTRACT

The invention relates to a method (31) for shaping a workpiece (2), in which the workpiece (2) is brought into contact with a tool (3) and, lying against the tool (3), is moved at a relative velocity (v_{R}) in relation to the tool (3), wherein the relative velocity (v_{R}) has a constant component (v_{K}) and a changing component (v_{S}). In order to reduce fabricating or shaping forces to be applied, it is provided according to the invention that a ratio of the changing component (v_{S}) to the constant component (v_{K}) is greater than or equal to 0.7.

The invention relates to a method of shaping a workpiece, wherein the workpiece is brought into contact with a tool and is moved with a relative velocity relative to the tool while in contact with the tool, wherein the relative velocity has a constant component and a changing component caused by an ultrasonic oscillation.

Methods of the aforementioned type are generally known. Ultrasonic oscillations are introduced, for example, into the workpiece or the tool in order to reduce the forces needed for shaping the workpiece.

It is the object of the invention to provide a method of shaping a workpiece wherein the required shaping forces are significantly reduced compared to conventional methods.

The object is solved with the aforementioned method in that a ratio of the changing component to the constant component is greater than or equal to 0.7.

The forces and moments produced during shaping are thus significantly reduced by this simple measure that less tool wear occurs and the useful life of the tool is thereby prolonged. The relative velocity modulated with the ultrasonic oscillation varies with the frequency of the ultrasonic oscillation, wherein the amplitude of the varying component of the relative velocity corresponds to the amplitude of the sound particle velocity of the ultrasonic oscillation. The amplitude of the sound particle velocity is thus subtracted from or added to the constant component of the relative velocity. The sound particle velocity thus indicates the velocity at which the ultrasound oscillation moves the workpiece or the tool about its rest position and about the constant component forming an offset velocity of the total relative velocity.

The solution according to the invention can be further improved by various individual advantageous embodiments that can be combined with one another in any configuration. These embodiments and their associated advantages will be discussed below.

The ratio may be between 0.7 and 5, so that the method can be easily performed with a device for shaping the workpiece.

In particular, when the ratio is greater than 1, i.e. when the changing component is greater than the constant component, a lift-off effect occurs, which significantly reduces the necessary shaping forces.

The apparatus may include the tool with which the workpiece can be contacted, and a transport device with which the workpiece can be moved relative to the tool with the relative velocity, and an ultrasound source connected to the tool for transmission of ultrasound or connectable to the workpiece. The apparatus is preferably configured to superimpose the ultrasound on the constant component of the relative movement with a sound particle velocity. To carry out the method, the transport device and the ultrasound source can be configured to generate the sound particle velocity at a ratio to the relative velocity of 0.7 or more, and in particular between 0.7 and 5, or greater than 1.

The frequency of the ultrasonic oscillation is preferably in a frequency range between 18 kHz and 60 kHz. The peak-to-peak amplitude of the ultrasonic oscillation is, for example, between 5 μm and 90 μm. The sound particle velocity of the ultrasonic oscillation is twice the amplitude of the ultrasonic oscillation multiplied by the frequency of the ultrasonic oscillation and with π (Pi). The tool or the workpiece is thus moved by the ultrasonic oscillation relative to the workpiece or the tool with a changing relative velocity.

Not only can the wear of the tool be reduced due to the reduction of the required shaping forces, but heating of the workpiece during shaping is also less than with conventional shaping methods, thus optionally obviating the need for coolants.

Due to the reduction of forces and in particular due to the lift-off effect, in particular oil-based lubricants can be replaced with other lubricants or the workpiece may even be shaped without the use of lubricants. Consequently, water may be incorporated as a lubricant between the tool and the workpiece during shaping. Water is inexpensive compared to petroleum-based lubricants and its disposal does not harm the environment. An additive may be added to the lubricant to enhance the properties to the lubricant. When the lubricant is based, for example, on water, the additive may be an oil, so that the water forms with the oil an emulsion having better lubricating properties than water alone.

Alternatively or additionally, a cleaning agent may be added to the lubricant and for example the water.

The superposition of ultrasound produces, in conjunction with a liquid, for example a lubricant such as oil, water or a mixture of water and oil or an additive, and in dependence on the amplitude of the ultrasonic oscillation, cavitation with different intensities at the tool. This produces, in parallel with a reduction in the force, a cleaning effect on the workpiece. This also increases the service life of the tool.

The cleaning effect can not only be achieved during shaping of the workpiece. Even when the workpiece is not being shaped, the cavitation causes the workpiece to be cleaned. In particular, when the tool slides past the workpiece, i.e. when the tool contacts the workpiece only slightly or is positioned at a short distance from the workpiece, the workpiece is cleaned by the cavitation caused by the superposition.

As already described above, according to the invention, a method for shaping and optionally cleaning of a workpiece is provided. Furthermore, a method for cleaning a workpiece is provided. In the method for shaping and optionally cleaning of a workpiece, the tool is brought into contact with the locations on the workpiece to be shaped. Areas of the workpiece that should only be cleaned need not be contacted. If the workpiece should only be cleaned, the tool need not be brought into contact with the workpiece. It is sufficient to bring the tool into the vicinity of the workpiece and to then carry out the remaining method steps. The tool is positioned sufficiently close to the workpiece, when vapor bubbles generated in the liquid by the cavitation lead to cleaning of the workpiece and, in particular, when the vapor bubbles contact at least partially the workpiece and/or the tool. For example, particles or other surface contaminants can thereby be removed from the workpiece.

Advantageously, the method for cleaning a workpiece is independent of the method of shaping a workpiece, and can in particular be carried out without the method step of bringing the tool into contact with the workpiece. However, it is advantageous for the cleaning to arrange the liquid between tool and workpiece.

By superimposing the constant component of the relative movement on the ultrasonic oscillation in proportion according to the invention, the method can be carried out with less mechanical complexity with respect to providing, processing and disposal of the lubricant.

A mixing ratio of lubricant, especially water, and additive can be between 60% lubricant to 40% additive, and up to 95% lubricant to 5% additive.

Alternatively, the shaping can be performed without introducing a lubricant between the tool and the workpiece. Especially when the ratio is greater than 1, it may be sufficient to shape the workpiece without a lubricant.

The ultrasonic oscillation is preferably a longitudinal oscillation which extends parallel to the constant component of the relative movement in a contact area where the workpiece contacts the tool. Consequently, the propagation direction of the ultrasonic oscillation is substantially in the direction of a manufacturing force component applied during the shaping of the workpiece. The ultrasonic oscillation modulates the total relative movement between the tool and the workpiece so that the relative movement has a component reciprocating with the sound particle velocity, i.e. the changing component. The constant component of the relative movement forms here an offset of the total relative movement between the workpiece and the tool, wherein this offset is greater than 0.

For example, the workpiece is a profile body shaped by pultrusion. The profile body is moved relative to the tool with the relative movement while contacting the tool.

The ultrasonic oscillation runs in the region of the tool preferably parallel to a drawing direction of the profile body. The relative movement then runs parallel to the drawing direction, wherein both the constant component and the changing component, i.e. the ultrasonic oscillation, of the relative movement run parallel to the drawing direction. The tool is, for example, a die having a die opening which extends through the die parallel to the relative movement. The workpiece may be a wire whose diameter is changed with the inventive method.

Alternatively, the workpiece may be machined, for example by milling, grinding or drilling. The ultrasonic oscillation and in particular the sound particle velocity is preferably aligned parallel to a tangent extending at a contact point of the workpiece where the tool contacts the workpiece.

In particular, the workpiece may be machined by turning, wherein the tool is in this case a lathe tool.

To align the ultrasonic oscillation parallel to the relative movement, the apparatus for shaping may include an ultrasound deflection device. The ultrasound deflection device is in itself advantageous and can be used independent of the method of the invention in order to change a propagation direction of the ultrasound. The ultrasound deflection device receives the ultrasound from the ultrasound source in a first propagation direction, which is oriented for example perpendicular to the relative movement. However, the ultrasound deflection device then radiates the deflected ultrasound in a second direction, for example to the tool or the workpiece or to the transport device, wherein the second direction is different from the first direction and extends for example parallel to the relative movement.

The first direction may thus have an angle with respect to the relative movement, and may, for example, run perpendicular thereto. The ultrasound deflection device is advantageously employed in particular during pultrusion, since due to the deflection, the ultrasound source may be arranged at a distance from a drawing path of the profile body. The drawing path may even pass through the ultrasound deflection device. For this purpose, the ultrasound deflection device may have at least one channel extending through the ultrasound deflection device parallel to the relative movement and thus parallel to the drawing path. A second channel, which may be coupled to the ultrasound source for receiving ultrasound, may extend through the ultrasound deflection device at an angle greater than 0 and in particular perpendicular to the relative movement. The two channels preferably intersect at the center of the ultrasound deflection device. The ultrasound deflection device can hence be referred to as a cross-coupler.

In a cross-section extending through the channels, the ultrasound deflection device is formed biconcave toward each side of the channels or with troughs recessed toward the intersection of the channels in the ultrasound deflection device, wherein the troughs are formed uniformly and without seams or edges. This makes it possible to redirect ultrasound without loss.

A zero-crossing of the ultrasonic oscillation occurs preferably at a location where the workpiece or the tool is clamped.

The invention will now be described with reference to exemplary embodiments and with reference to the drawings. The different features of the embodiments can be combined independently of one another, as has already been explained for the individual advantageous examples.

The drawings show in:

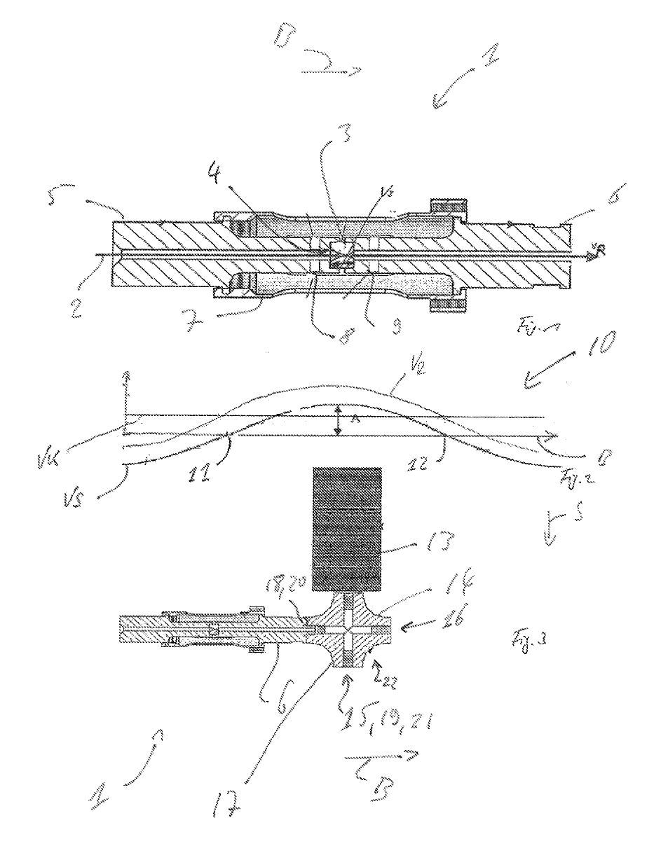

FIG. 1 a schematic diagram of a first exemplary embodiment of an apparatus for shaping a workpiece that carries out an exemplary embodiment of the method according to the present invention;

FIG. 2 a schematic diagram of a relative velocity between a tool and a workpiece when carrying out the method according to the present invention;

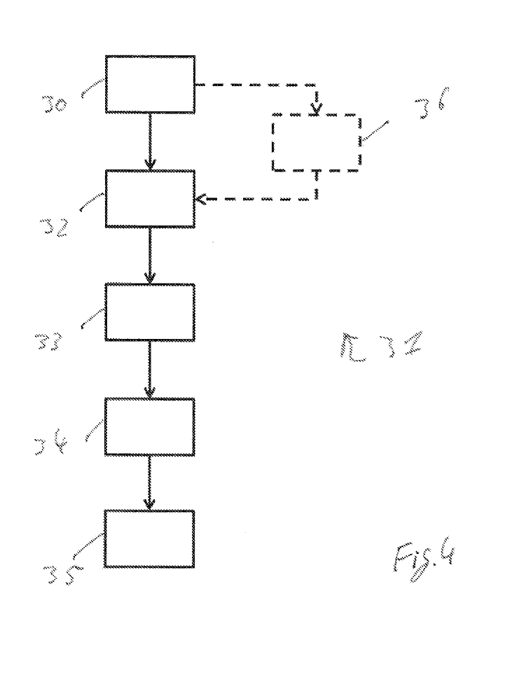

FIG. 3 a schematic diagram of a further exemplary embodiment of an apparatus for carrying out the method according to the present invention; and

FIG. 4 a schematic diagram of an exemplary embodiment of the method according to the present invention.

The structural design and the operation of an apparatus for carrying out the method according to the present invention will now be described with reference to the exemplary embodiment of FIG. 1.

FIG. 1 shows an exemplary embodiment of an apparatus 1 for shaping a workpiece 2 in a schematic sectional view, wherein the apparatus 1 includes a tool 3, with which the workpiece 2 can be shaped.

In the embodiment of FIG. 1, the apparatus 1 is shown in cross-section as an apparatus 1 for pultrusion of the workpiece 2 along a machining direction B. The work piece 2 is, for example, a wire whose diameter is to be changed, and in particular reduced, using the apparatus 1. The workpiece 2 is conveyed to the tool 3 constructed as a die and passes through a die opening 4 which extends through the tool 3. The workpiece 2 extends in the machining direction B, in which the workpiece 2 is moved relative to the tool 3 and, more particularly, through its die opening 4 at least in the area of the tool 3 and in its die opening 4. The workpiece 2 has a non-machined shape in the machining direction B in front of the tool 3, and has a machined shape in the machining direction B behind the tool 3 with, for example, the smaller diameter.

The workpiece 2 is therefore moved parallel to the machining direction B with a relative velocity v_{R} parallel to the machining direction B while contacting the tool 3.

In addition, the apparatus 1 has for example two clamping members 5, 6. The clamping members 5, 6 are braced against one another by a clamping sleeve 7 so that the tool 3 is pressed between the clamping members 5, 6. The clamping members 5, 6 are constructed, for example, such that the workpiece 2 passes therethrough.

The clamping members 5, 6 can each have openings 8, 9 for supplying or discharging coolants or lubricants. If the workpiece can be shaped without using coolants or lubricants moldable, then the clamping members 5, 6 can also be constructed without the openings 8, 9.

During shaping of the workpiece 2, the relative velocity v_{R} is modulated with an ultrasonic oscillation, wherein a sound particle velocity of the ultrasonic movement represents a varying component v_{S} of the relative velocity v_{R}. The ultrasonic oscillation oscillates back and forth parallel to the relative velocity v_{R} or to the machining direction B, and is preferably a longitudinal oscillation, which is superimposed on a constant component of v_{K} of the relative movement. The applied manufacturing forces are reduced by superimposing the constant component v_{K} of the relative movement on the ultrasonic oscillation, thus obviating, for example, the need for the coolants or lubricants when shaping the workpiece 2.

The ultrasonic oscillation may be introduced into the tool 3, for example, via at least one of the clamping members 5, 6 and/or via the clamping sleeve 7. Alternatively, the ultrasonic oscillation may be introduced into the workpiece 2. For example, the apparatus 1 may include a transport apparatus for moving the workpiece 2, which connects an ultrasound source to the workpiece 2 for transmitting ultrasound.

FIG. 2 shows schematically an amplitude curve 10 of the relative velocity v_{R} and of the constant component v_{K} of the relative velocity v_{R} and of the varying component of the relative velocity v_{R} by the ultrasonic oscillation. The ultrasonic oscillation is a longitudinal oscillation extending in the machining direction B, which forms, for example, a standing wave with stationary nodes 11, 12. An amplitude A of the ultrasound oscillation is always 0 in the region of the nodes 11, 12. The nodes 11, 12 of the ultrasonic oscillation are preferably disposed in the region of contact points of the clamping sleeve 7 and of the clamping members 5, 6, via which the clamping sleeve 7 introduces a clamping force in the clamping members 5, 6. In particular when the ultrasonic oscillation moves the tool 3 and optionally also the clamping members 5, 6 and/or the clamping sleeve 7 back and forth with the sound particle velocity, mechanical stress on the clamping sleeve 7 is reduced by arranging the nodes 11, 12 in the region of the contact points between the clamping sleeve 7 and the clamping members 5, 6, thus prolonging the service life of the clamping sleeve 7. The ultrasonic oscillation can therefore move the rest position of the tool 3 back and forth parallel to the machining direction B with the sound particle velocity m, wherein the sound particle velocity is the changing component v_{S} of the relative movement v_{R}.

The sound particle velocity can be represented as a product of the amplitude A with the angular frequency of the ultrasonic oscillation. The constant component v_{K} of the relative movement v_{R} between the workpiece 2 and the tool 3 does not change over time during the shaping of the workpiece 2.

In the exemplary embodiment of FIG. 2, the ratio of the changing component v_{S} of the relative movement v_{R} to its constant component v_{K} is greater than 1. The constant component v_{K} is thus smaller than the changing component v_{S}.

FIG. 3 shows schematically another exemplary embodiment of the apparatus 1 in a sectional view, wherein the same reference symbols are used for elements that correspond in function and/or structure to elements of the exemplary embodiment of FIG. 1. For sake of brevity, only the differences from the exemplary embodiment of FIG. 1 will be discussed.

FIG. 3 shows the apparatus 1 of the exemplary embodiment of FIG. 1 cut along the machining direction B and additionally with an ultrasound source 13 and an ultrasound deflection device 14. The ultrasound deflection device 14 connects the ultrasound source 13 to the clamping member 6 for transmission of ultrasound. During operation, the ultrasound source 13 generates ultrasound, which is introduced by the ultrasound deflection device 14 into the clamping member 6, and from there into the tool 3.

The ultrasound source 13 generates the ultrasonic oscillation as a longitudinal oscillation, whose oscillation direction S is tilted relative to the machining direction B and extends, for example, at an angle of 90° with respect to the machining direction B. During operation, the ultrasound source 13 emits the ultrasonic oscillation, which oscillates in the oscillation direction S, toward the ultrasound deflection device 14. The ultrasound deflection device 14 emits the ultrasonic oscillation, which is still a longitudinal oscillation, in a different direction and in particular to the clamping member 6 after deflection into the machining direction B, with the clamping member 6 in turn exciting the tool 3 to perform a longitudinal ultrasonic oscillation parallel to the machining direction B and with the sound particle velocity.

The ultrasound deflection device 14 is formed with two channels 15, 16 extending in different directions through the ultrasound deflection device 14. In the exemplary embodiment of FIG. 3, the channels 15, 16 are formed perpendicular to each other in the form of a cross, so that the ultrasound deflection device 14 can also be referred to as a cross-coupler, with which the ultrasound source 13 can be coupled with the clamping member 6 for transmission of ultrasound. The channel 15 extends through the ultrasound deflection device 14 parallel to the oscillation direction S. The channel 16 extends, for example, parallel to the machining direction B, so that in particular the workpiece 2 constructed as a profile body can be moved by the channel 16 away from the tool 3 or toward the tool 3.

FIG. 3 shows the ultrasound deflection device 14 along the channels 15, 16 in cross-section. A base body 17 of the ultrasound deflection device 14, through which the channels 15, 16 extend, has a biconcave shape on at least one side of at least one of the channels 15, 16. The channels 15, 16 abut discharge openings 18, 19, into which the channels 15, 16 open away from the ultrasound deflection device 14. The discharge openings 18, 19 are disposed in end faces 20, 21 of the ultrasound deflection device 14, where for example, the clamping member 6 or the ultrasound source 13 can be attached for transmission of ultrasound. The base body 17 has a trough 22 disposed between the discharge opening 18 of the channel 16 and the discharge opening 19 of the channel 15, wherein the trough 22 is formed for example as a circular arc-shaped recess caused by the biconcave shape of the base body 17. In the region of the end faces 20, 21, the ends of the trough 22 may extend parallel to the machining direction B and/or parallel to the oscillation direction S.

FIG. 4 shows schematically the inventive method in form of a flow diagram, wherein the same reference symbols are used for elements that correspond in function and/or structure to the elements of the exemplary embodiments of the previous figures. For sake of brevity, only the differences from the previous exemplary embodiments will be discussed below.

The method 31 starts with a first method step 30. For example, in the method step 30, the apparatus 1 for shaping of the workpiece 2 is started up.

The method step 32 follows the method step 30, where the workpiece 2 is brought into contact with the tool 3. After the workpiece 2 has been brought into contact with the tool 3 in method step 32, the ultrasonic oscillation is introduced either into the workpiece 2 or into the tool 3, thereby generating the relative movement v_{R} with the changing component v_{S} between the workpiece 2 and the tool 3. In the subsequent method step 33, the workpiece 2 contacting the tool 3 is additionally moved relative to the tool 3 with the constant component v_{K} of the relative movement v_{R} and thereby shaped. The method step 34, where the method 31 ends, follows the method step 35.

The successive method steps 32 and 33 can in the illustrated exemplary embodiment of the method 31 also be performed in a reverse order. Optionally, a method step 36 may be arranged between the method steps 30 and 32, in which a cooling and/or lubricant is provided and disposed, for example, between the workpiece 2 and the tool 3.

### LIST OF REFERENCE NUMERALS

1 Apparatus
2 Work
3 Tool
4 Die opening
5, 6 Clamping member
7 Clamping sleeve
8, 9 Discharge openings
10 Amplitude response
11, 12 Nodes
13 Ultrasound source
14 Ultrasound deflection device
15, 16 Channel
17 Body
18, 19 Openings
20, 21 End faces
22 Trough
30 Start
31 Method
32 Bring into contact
33 Introduce ultrasound
34 Move
35 End
36 Introduce coolant/lubricant
A Amplitude
B Machining direction
S Oscillation direction
v_{R} Relative velocity
v_{S} Changing component of the relative velocity
v_{K} Constant component of the relative velocity

1. A method for shaping a workpiece, wherein the workpiece is brought into contact with a tool and, while in contact with the tool, is moved relative to the tool with a relative velocity, wherein the relative velocity has a constant component and a changing component caused by an ultrasonic oscillation, wherein a ratio of the changing component to the constant component is greater than or equal to 0.7, and wherein, in a contact area, where the workpiece is in contact with the tool, the ultrasonic oscillation is a longitudinal oscillation, which extends parallel to the constant component of the relative velocity.

2. The method according to claim 1, wherein the ratio is between 0.7 and 5.

3. (canceled)

4. The method according to claim 1, wherein the workpiece is a profile body, which is formed by pultrusion.

5. The method according to claim 1, wherein in the region of the tool, the ultrasonic oscillation extends parallel to a machining direction of the workpiece.

6. The method according to claim 1, wherein a fluid is introduced between the tool and the workpiece, and that cavitation is generated in the fluid by the ratio of the changing component to the constant component.

7. The method according to claim 1, wherein during shaping, water is introduced between the tool and the workpiece.

8. The method according to claim 7, wherein an additive is added to the water.

9. The method according to claim 1, wherein the workpiece is shaped without a lubricant.
